(19) United States
(12) Patent Application Publication
(10) Pub. No.: US 2016/0034404 A1
(43) Pub. Date: Feb. 4, 2016

(54) MANAGING ACCESS TO STORAGE

(71) Applicant: International Business Machines Corporation, Armonk, NY (US)

(72) Inventors: Bard A. Doster, Tucson, AZ (US); Joseph V. Malinowski, Bridgeview, IL (US); David C. Reed, Tucson, AZ (US); Max D. Smith, Tucson, AZ (US)

(21) Appl. No.: 14/448,072

(22) Filed: Jul. 31, 2014

(51) Int. Cl. G06F 12/14; G06F 3/06; G06F 17/30

(52) U.S. Cl. CPC G06F 12/1483; G06F 17/30091; G06F 3/0622; G06F 3/0637; G06F 3/067; G06F 2212/1052; G06F 2212/154

(57) ABSTRACT

A method, system, and computer program product for managing data in a storage facility is disclosed. A data set is selected for management based on a usage factor and a value factor. In a control block for the data set, a permissible address-range for access to a unit of storage space is established. A requested address-range of an access request configured for the unit of storage space is identified. By comparing the permissible address-range and the requested address-range, a determination is made whether to process the access request. An event response is initiated in response to determining to disallow processing of the access request.

### BACKGROUND

This disclosure relates generally to computer systems and, more particularly, relates to managing a data set in a storage system. The amount of data that needs to be managed by enterprises is growing at an extremely high rate. Management of storage environments may need to be performed with as few errors as possible. As data needing to be managed increases, the need for management efficiency may increase.

### SUMMARY

Aspects of the disclosure include a method, system, and computer program product for managing data in a storage facility (i.e., storage system). A data set is selected for management based on a usage factor and a value factor. In a control block for the data set, a permissible address-range for access to a unit of storage space is established. A requested address-range of an access request configured for the unit of storage space is identified. By comparing the permissible address-range and the requested address-range, a determination is made whether to process the access request.

Aspects of the disclosure monitor the permissible address-range configured to be accessed and, to protect from overlaying data, prevent access outside the permissible address-range. In response to determining to disallow processing of the access request an event response can be initiated. In embodiments, the event response includes an end to the access request, a disallowance notification for the access request, or a storage dump of diagnostic information.

In embodiments, before establishing the permissible address-range and identifying the requested address-range, a particular data set can be selected based on a factor (e.g., usage or value). The factor may include a set of jobs which open the data set, a regularity threshold of opens of the data set, a profile catalog coupled to the data set, an activity threshold for the storage system, or a user-provided profile for the data set which meets a priority threshold. Altogether, aspects of the disclosure provide a methodology for managing a data set that may provide performance or efficiency benefits when managing access to storage.

### BRIEF DESCRIPTION OF THE DRAWINGS

FIG. 1 illustrates an example network architecture according to embodiments;

FIG. 2 illustrates an example storage system containing an array of storage devices according to embodiments;

FIG. 3 is a flowchart illustrating a method for managing data in a storage system according to embodiments; and

FIG. 4 shows modules of a system for managing a storage facility according to embodiments.

### DETAILED DESCRIPTION

Aspects of the disclosure relate to data storage for circumstances where a plurality of applications may attempt to access the same data of a data set (e.g., multiple sysplexes configured to access the same data). For example, features provide a usage and value algorithm for enabling protection of a data set by listings (e.g., listings in a particular control block such as a data extent block) of extents to be protected from overlaying. In embodiments when features are enabled, an attempted access that would result in overlaying produces an event response that can include diagnostic collection (to find the source of the attempt).

Overlayed data can provide challenges for users. If appropriate current backups of overlayed data sets are not available, data loss can be the result. Diagnosing such challenges can be intricate, complex, or multi-faceted. For example, an identified program may be suspected to be a cause, but a component may not exist to prove the identified program overlayed a file. Similarly, a component may not exist to gather documentation to allow the program owners to diagnose a root cause of the event. A diagnostic methodology could allow for quicker diagnosis or deterrence/prevention of overlaying incorrect areas on a disk. According to embodiments, a layer of deterrence/protection may be added and diagnosis can be enabled/disabled at a data set or Input/Output (I/O) driver level.

Aspects of the disclosure include a method, system, and computer program product for managing data in a storage facility (i.e., storage system). The method, system, and computer program product may work on a number of operating systems. The management methodology may include a plurality of operations/actions for computer-implementation. In a control block for a data set, a permissible address-range for access to a unit of storage space is established. A requested address-range of an access request configured for the unit of storage space is identified. By comparing the permissible address-range and the requested address-range, a determination is made whether to process the access request.

Aspects of the disclosure monitor the permissible address-range configured to be accessed and, to protect from overlaying data, prevent access outside the permissible address-range. Comparing the permissible address-range and the requested address-range can include determining whether the requested address-range is within the permissible address-range. In response to determining at least a portion of the requested address-range is not within the permissible address-range, it may be determined to disallow processing of the access request. In response to determining to disallow processing of the access request an event response can be initiated. In embodiments, the event response includes an end to the access request. In embodiments, the event response includes a disallowance notification for the access request. In embodiments, the event response includes a storage dump of diagnostic information having a relationship to both the permissible address-range and the requested address-range. The storage dump may include temporal information configured to be relatable to a specific program.

In embodiments, before establishing the permissible address-range and identifying the requested address-range, a particular data set can be selected (e.g., selected to use the methodology, the selection from a group of data sets) based on a factor (e.g., usage or value). The factor may be used to determine a specific data set to protect (e.g., based on worthiness). The factor may include a set of jobs which open the data set. The factor can have a regularity threshold of opens of the data set. The factor can include a profile catalog coupled to the data set. The factor may have an activity threshold for the storage system. The factor can include a user-provided profile for the data set which meets a priority threshold. Combinations of such factors can have positive impacts on performance or efficiency. Altogether, aspects of the disclosure provide a methodology for managing a data set that may provide performance or efficiency benefits when managing access to storage.

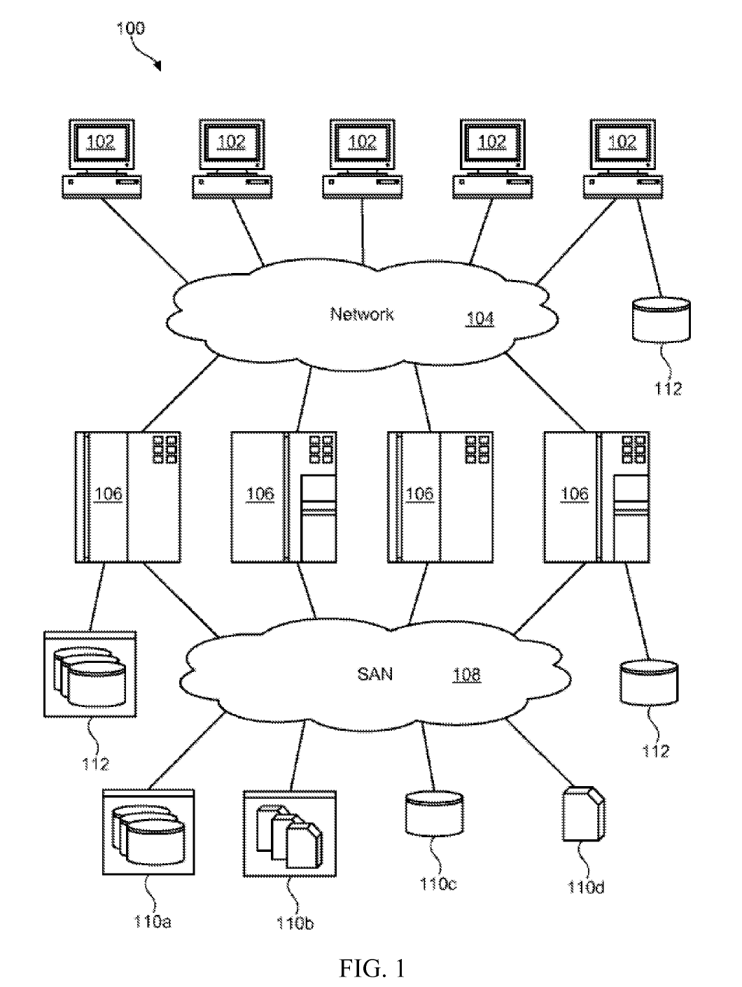

FIG. 1 illustrates an example network architecture 100 according to embodiments. The network architecture 100 is presented to show one example of an environment where a system and method in accordance with the disclosure may be implemented. The network architecture 100 is presented only by way of example and is not intended to be limiting. The system and methods disclosed herein may be applicable to a wide variety of different computers, servers, storage devices, and network architectures, in addition to the network architecture 100 shown.

As shown, the network architecture 100 includes one or more computers 102, 106 interconnected by a network 104. The network 104 may include, for example, a local-area-network (LAN), a wide-area-network (WAN), the Internet, an intranet, or the like. In certain embodiments, the computers 102, 106 may include both client computers 102 and server computers 106 (also referred to herein as “host systems” 106 or alternatively as “host devices”). In general, client computers 102 may initiate communication sessions, whereas server computers 106 may wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like. One or more of the storage systems 112 may contain storage pools that may benefit from techniques of the disclosure.

The network architecture 100 may, in certain embodiments, include a storage network 108 behind the servers 106, such as a storage-area-network (SAN) or a LAN (e.g., when using network-attached storage). This network 108 may connect the servers 106 to one or more storage systems 110 (alternatively, remote systems or remote devices), such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may contain storage pools that may benefit from techniques according to the disclosure.

In embodiments, techniques of the disclosure may permit the storage pools of storage systems 110, 112 to protect a data set from overlaying. Therefore, the methodology provided may allow for protection of the data set from overlaying in relation to the example network architecture 100 illustrated by FIG. 1.

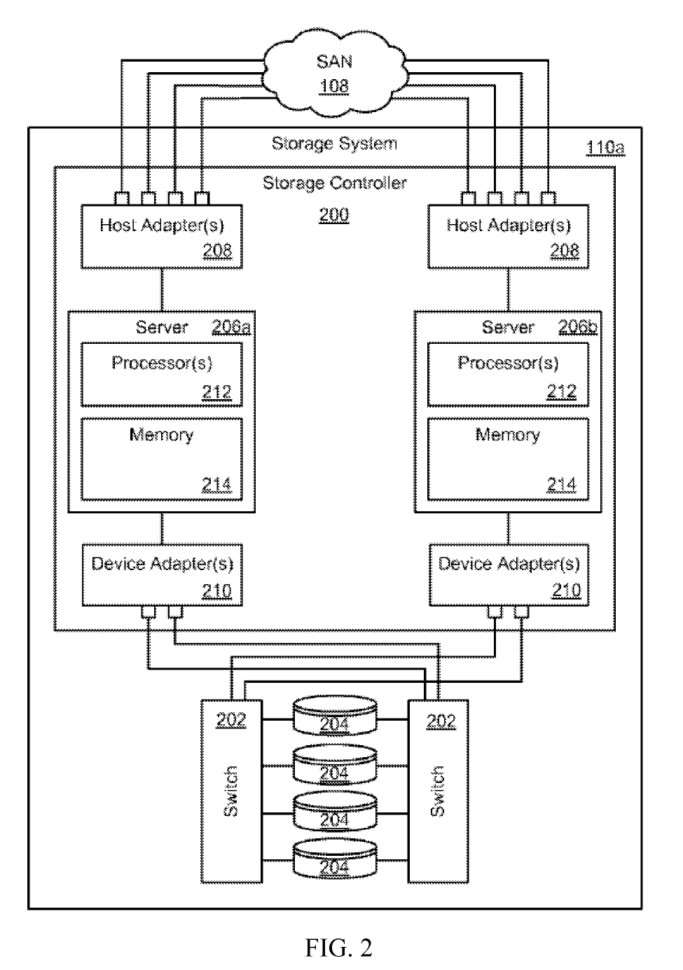

FIG. 2 illustrates an example storage system 110a containing an array of storage devices 204 (e.g., hard-disk drives and/or solid-state drives) according to embodiments. The internal components of the storage system 110a are shown in accordance with the disclosure and may be used to manage such a storage system 110a. Nevertheless, techniques according to the disclosure may also be implemented within other storage systems 110, 112. As shown, the storage system 110a includes a storage controller 200, one or more switches 202, and one or more storage devices 204, such as hard-disk drives or solid-state drives (e.g., flash-memory-based drives). The storage controller 200 may enable one or more hosts 106 (e.g., open system and/or mainframe servers 106) to access data stored in the one or more storage devices 204.

As shown in FIG. 2, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may remain functional to ensure that I/O is able to continue between the hosts 106 and the storage devices 204. This process may be referred to as a “failover.”

Particular enterprise storage systems may have a storage system 110a having an architecture similar to that illustrated in FIG. 2. Particular enterprise storage systems may include a high-performance, high-capacity storage controller providing disk storage that is designed to support continuous operations. Particular enterprise storage systems may use servers 206a, 206b, which may be integrated with a virtualization engine technology. Nevertheless, techniques according to the disclosure are not limited to any specific enterprise storage system 110a, but may be implemented in any comparable or analogous storage system 110 regardless of the manufacturer, product name, or components or component names associated with the storage system 110. Any storage system 110 that could benefit from techniques according to the disclosure is deemed to fall within the scope of the disclosure. Thus, the enterprise storage system shown is presented only by way of example and is not intended to be limiting.

In selected embodiments, each server 206 includes one or more processors 212 (e.g., n-way symmetric multiprocessors) and memory 214. The memory 214 may include volatile memory (e.g., RAM) as well as non-volatile memory (e.g., ROM, EPROM, EEPROM, hard disks, flash memory, etc.). The volatile memory and non-volatile memory may store software modules that run on the processor(s) 212 and are used to access data in the storage devices 204. The servers 206 may host at least one instance of these software modules. These software modules may manage all read and write requests to logical volumes in the storage devices 204.

In embodiments, techniques of the disclosure may permit the storage devices 204 to protect a data set from overlaying. Therefore, the methodology provided may allow for protection of the data set from overlaying in relation to the example storage system 110a containing an array of storage devices 204 illustrated by FIG. 2.

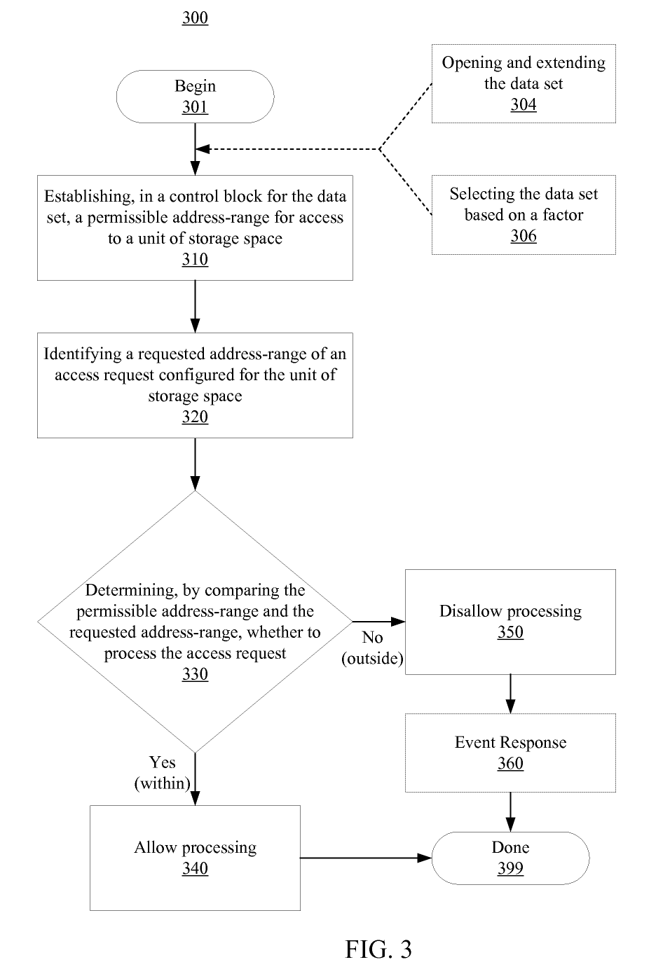

FIG. 3 is a flowchart illustrating a method 300 for managing data in a storage system according to embodiments. Aspects of method 300 may include monitoring a permissible address-range configured to be accessed and, to protect from overlaying data, preventing access outside the permissible address-range. As such, aspects may write-protect specific areas of data. Opening the data set can serve as a triggering event (e.g., to initiate the disclosed operations). The data set may be extended (e.g., including frequent extending of the data set), which can serve as another triggering event or together with opening the data set as one triggering event as at block 304. Method 300 may begin at block 301.

The data set may be selected based on a usage factor or a value factor. In embodiments, before establishing the permissible address-range and identifying a requested address-range, a particular data set can be selected (e.g., selected to use the methodology, the selection from a group of data sets) based on a factor at block 306. The factor may include a set of jobs which open the data set (e.g., a subject-matter type such as inventory-oriented jobs as opposed to payroll-oriented jobs). The factor can have a regularity threshold of opens of the data set (e.g., a temporal threshold such as opened more than once per hour as opposed to opened roughly once per day). The factor can include a profile catalog coupled to the data set (e.g., a user-selected listing that includes/excludes jobs based on a user-input or predetermined criteria). The factor may have an activity threshold for the storage system (e.g., activity/usage levels/periods for certain records such as that related to overhead burdens). The factor can include a user-provided profile for the data set which meets a priority threshold (e.g., prioritizing use of the disclosed operations and potentially dynamically adjusting/activating/deactivating at least a portion of items based on system activity). In embodiments, a user may provide a group of data sets to be monitored in a specific order (e.g., prioritized order) in a parameter library configuration member. As such system overhead or activity levels increase, the group of data sets being monitored can be reduced (e.g., reduced proportionally). Such interaction may allow for dynamic activation/deactivation of aspects of the disclosure based on system activity. Combinations of such factors can have positive impacts on performance or efficiency. For example, using both a usage factor (e.g., configured for data set update frequency/infrequency) and a value factor (e.g., configured for data sets specifically identified as performance challenged) may provide the storage facility with such benefits.

In a control block for the data set, the permissible address-range for access to a unit of storage space is established at block 310. In embodiments, a channel program receives the permissible address-range (as transmitted or published from the control block). For example, extent information for the data set can be saved into an existing/created control block. When the data set extends, the extent information is updated to reflect the new extent range. The new extent range may be the permissible address-range for writes to the data set. An extent may be one or more adjacent tracks of data within the file system. The extent can be presented by a starting and ending track address value. To illustrate, the permissible address-range or CCHH Cylinder Head each 2 bytes could include LOW-CCHH-----X‘00010000’ HIGH-CCHH----X‘0002000E’ would represent one extent range of 30 tracks.

A requested address-range of an access request configured for the unit of storage space is identified at block 320. In embodiments, the channel program identifies the requested address-range. For example, a specific extent may be used to identify where data will be written. The specific extent can thereafter be used to validate a valid access request or detect a potentially invalid access request. For example, the request address range could be LOW-CCHH-X‘00010000’ HIGH-CCHH-X‘0001000E’, LOW-CCHH-X‘0000000B’ HIGH-CCHH-X‘00030000’, LOW-CCHH-X‘0000000B’ HIGH-CCHH-X‘00020000’, LOW-CCHH-X‘00020000’ HIGH-CCHH-X‘00030000’, or LOW-CCHH-X‘00010000’ HIGH-CCHH-X‘0002000E’.

By comparing the permissible address-range and the requested address-range, a determination is made whether to process the access request at block 330. Comparing the permissible address-range and the requested address-range can include determining whether the requested address-range is within the permissible address-range. For example, ranges LOW-CCHH-X‘00010000’ HIGH-CCHH-X‘0001000E’ and LOW-CCHH-X‘00010000’ HIGH-CCHH-X‘0002000E’ are within LOW-CCHH-----X‘00010000’ HIGH-CCHH----X‘0002000E’. In response to determining the requested address-range is within the permissible address-range, it may be determined to allow processing of the access request at block 340 (e.g., an example access request for LOW-CCHH-X‘00010000’ HIGH-CCHH-X‘0001000E’ or LOW-CCHH-X‘00010000’ HIGH-CCHH-X‘0002000E’ could be processed). In response to determining at least a portion of the requested address-range is not within the permissible address-range, it may be determined to disallow processing of the access request at block 350. For example, LOW-CCHH-X‘0000000B’ HIGH-CCHH-X‘00030000’ (outside the lower, the upper, and the length), LOW-CCHH-X‘0000000B’ HIGH-CCHH-X‘00020000’ (outside lower), or LOW-CCHH-X‘00020000’ HIGH-CCHH-X‘00030000’ (outside upper) may be disallowed from processing because each is outside the permissible address-range of LOW-CCHH-----X‘00010000’ HIGH-CCHH----X‘0002000E’.

In response to determining to disallow processing of the access request an event response can be initiated at block 360. In embodiments, the event response includes an end to the access request (e.g., discarding, disregarding, terminating). In embodiments, the event response includes a disallowance notification for the access request (e.g., sending a message to a user or system administrator). In embodiments, the event response includes a storage dump of diagnostic information having a relationship to both the permissible address-range and the requested address-range. The storage dump may include temporal information configured to be relatable to a specific program.

Diagnostic information may include at least one of error information, data from a data set, metadata about a data set, system data, application history, performance information, or input-output (I/O) tracing. Dumping may include capturing, collecting, or saving off in a different data space. Dumping may include recording data elsewhere (e.g., disk, nonvolatile memory) for use in subsequent problem analysis. For instance, if a prospective extent does not fall within the permissible address-range, the request may be rejected and an abnormal end (abend) can be taken (providing protection from accidental or malicious data overlays). The abend can generate a storage dump at the time of the attempted overlay, which contains the storage information at the time of the request. As such, identification of the application/program/job in error may be facilitated, since it may be captured at the exact time of the erroneous write attempt.

Method 300 may conclude at block 399. Aspects of method 300 may provide performance or efficiency benefits when managing access to storage. For example, features provide a usage and value algorithm for enabling protection of a data set by listings (e.g., listings in a particular control block such as a data extent block) of extents to be protected from overlaying. In embodiments when features are enabled, an attempted access that would result in overlaying produces an event response that can include diagnostic collection (to find the source of the attempt). Altogether, a storage system may be managed more efficiently.

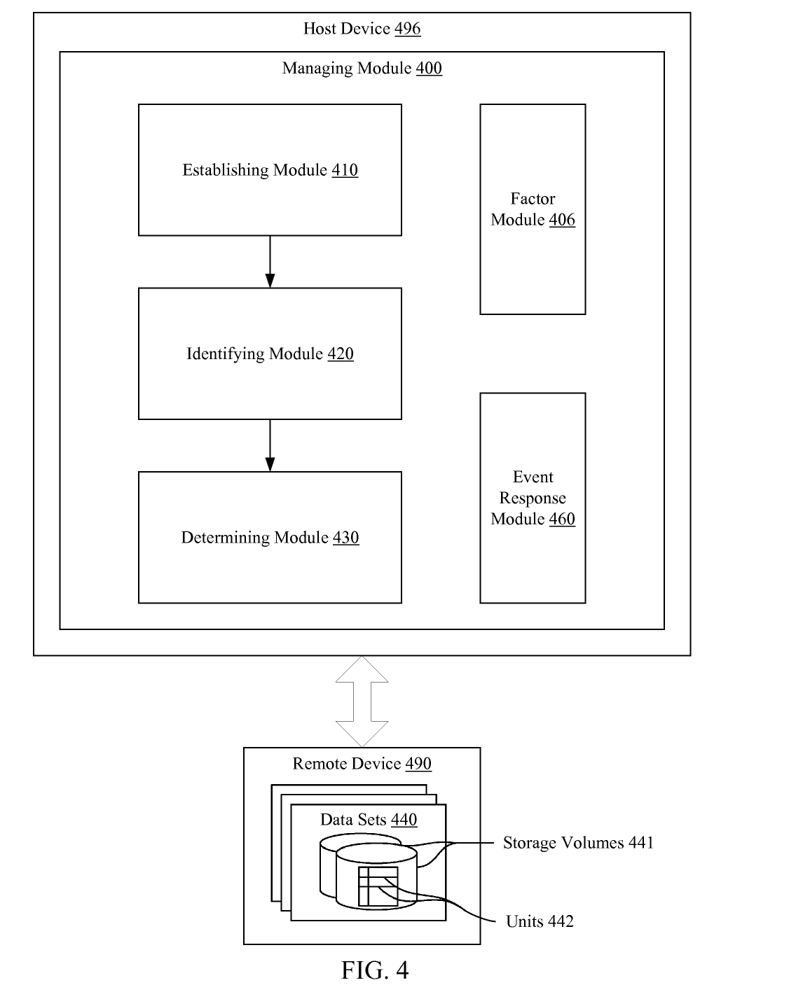

FIG. 4 shows modules of a system for managing a storage facility according to embodiments. In embodiments, method 300 may be implemented using one or more modules of FIG. 4. As such, all aspects of the discussion related to FIG. 3 and method 300 may be used/applied/implemented in the system. The modules of FIG. 4 may be implemented in hardware, software or firmware executable on hardware, or a combination thereof. For example, module functionality that may occur in a host device 496 may actually be implemented in a remote device 490 and vice versa. Other functionality may be distributed across the host device 496 and the remote device 490. The remote device 490 may have data sets 440 comprising storage volumes 441 having units 442 which can be extents. The host device 496 may include a managing module 400.

The managing module 400 may be configured and arranged to manage a storage facility. Managing module 400 can add a layer of protection and diagnosis that can be enabled or disabled at a data set or input-output (I/O) driver level. When managing module 400 is enabled, an extent list of a data set being processed can be used as a safety check before channel program is issued to a channel. When the data set is opened, the extent information for the data set may be saved into a Data Extent Block (DEB). The DEB may be a particular control block directly linked/associated/coupled to the data set (e.g., the data set chosen for overlay protection) configured to store the permissible address-range. When the data set extends, this information can be updated in the DEB to reflect a new extent range. When an I/O request is made, a specific extent may be used to identify where the data will be written. If this specific extent does not fall within the extent range identified in the DEB, an error message may be issued and a storage dump can be captured. The managing module 400 may include an establishing module 410 (see discussion related to FIG. 3, block 310), an identifying module 420 (see discussion related to FIG. 3, block 320), a determining module 430 (see discussion related to FIG. 3, block 330), a factor module 406 (see discussion related to FIG. 3, block 306), and an event response module 460 (see discussion related to FIG. 3, block 360).

A data set that has been opened by an application can have a Data Extent Block (DEB) that contains extent information for the data set by using the establishing module 410. The DEB address is passed to Execute Channel Program (EXCP) and used to validate the I/O request. Before the I/O is (fully) issued, the extent (in the channel program) may be identified by the identifying module 420 and be compared to the valid range of extents in the DEB as established in the establishing module 410. Such comparison may be performed by the determining module 430. If the extent does not fall within the valid range, the request may be rejected and an abnormal end (abend) can be taken using the event response module 460. The rejection may provide deterrence/protection from accidental or malicious data overlays. The abend may generate a storage dump at the time of the attempted overlay, which can contain the storage information at the time of the request. Thus, the program in error can be discerned since it is captured at the time of the (erroneous) write attempt.

The layer of data protection can be turned on for specific datasets when they are being opened by the application. An application developer can positively influence performance impact by only selecting the datasets affected by the problem using a usage/value algorithm based on factors using the factor module 406. The application developer can also turn this on for (all) data sets opened within a specific job or list of jobs by specifying such when activating a trace. If a user does not want to trace certain data sets that may be accessed frequently or unknowingly, a special exclude list can also be added in order to avoid monitoring such data sets. For example, system datasets can be updated frequently without any direct involvement from the application code. Another option provided to the user is to enable and disable the data protections for a list of data sets based on preference thresholds. Analysis of activity levels on the system through Resource Measurement Facility (RMF) records may be performed. Low and high activity period ranges may be identified. The data protection can be turned on during periods of expected low usage. The monitoring can also be turned off when system overhead reaches threshold levels set by the user in order to positively influence performance impact during peak workload periods. Another example option includes the user providing a list of data sets to be monitored in prioritized order in a parameter library configuration member. As the system overhead or activity levels increase, the number of data sets being monitored can be reduced. Such adaptations could allow the activation and deactivation to be dynamic based on system activity.

Aspects of managing module 400 may provide performance or efficiency benefits when managing access to storage. For example, features provide a usage and value algorithm for enabling protection of a data set by listings (e.g., listings in a particular control block such as a data extent block) of extents to be protected from overlaying. In embodiments when features are enabled, an attempted access that would result in overlaying produces an event response that can include diagnostic collection (to find the source of the attempt). Altogether, a storage system may be managed more efficiently.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow.

What is claimed is:

1. A computer-implemented method for managing data in a storage system, the method comprising:
establishing, in a control block for a data set, a permissible address-range for access to a unit of storage space;
identifying a requested address-range of an access request configured for the unit of storage space; and
determining, by comparing the permissible address-range and the requested address-range, whether to process the access request.

2. The method of claim 1, further comprising selecting the data set based on a usage factor and a value factor.

3. The method of claim 1, further comprising:
initiating, in response to determining to disallow processing of the access request, an event response.

4. The method of claim 3, wherein the event response includes an end to the access request.

5. The method of claim 3, wherein the event response includes a disallowance notification for the access request.

6. The method of claim 3, wherein the event response includes a storage dump of diagnostic information having a relationship to both the permissible address-range and the requested address-range.

7. The method of claim 6, wherein the storage dump includes temporal information configured to be relatable to a specific program.

8. The method of claim 1, wherein comparing the permissible address-range and the requested address-range includes determining whether the requested address-range is within the permissible address-range.

9. The method of claim 8, further comprising:
monitoring the permissible address-range configured to be accessed; and
determining, to prevent access outside the permissible address-range to protect from overlaying, to disallow processing of the access request in response to determining at least a portion of the requested address-range is not within the permissible address-range.

10. The method of claim 1, wherein establishing, in the control block for the data set, the permissible address-range for access to the unit of storage space occurs in response to:
opening the data set; and
extending the data set.

11. The method of claim 1, wherein a channel program both identifies the requested address-range and receives, from the control block, the permissible address-range.

12. The method of claim 1, further comprising selecting, before establishing the permissible address-range and identifying the requested address-range, the data set based on at least one factor chosen from:
a set of jobs which open the data set;
a regularity threshold of opens of the data set;
a profile catalog coupled to the data set;
an activity threshold for the storage system; and
a user-provided profile for the data set which meets a priority threshold.

13. A system for managing a data set in a storage facility, comprising:
a remote device; and
a host device, at least one of the remote device and the host device including a managing module, the managing module comprising:
an establishing module to establish, in a control block for the data set, a permissible address-range for access to a unit of storage space;
an identifying module to identify a requested address-range of an access request configured for the unit of storage space; and
a determining module to determine, by comparing the permissible address-range and the requested address-range, whether to process the access request.

14. The system of claim 13, further comprising a factor module to select the data set based on a usage factor and a value factor.

15. The system of claim 14, further comprising:
an event response module to initiate, in response to determining to disallow processing of the access request, an event response.

16. The system of claim 15, wherein the event response includes an end to the access request and a disallowance notification for the access request.

17. The system of claim 15, wherein the event response includes a storage dump of diagnostic information having a relationship to both the permissible address-range and the requested address-range, wherein the storage dump includes temporal information configured to be relatable to a specific program.

18. The system of claim 13, wherein the control block for the data set is a data extent block directly linked to the data set, the data extent block configured to store the permissible address-range.

19. The system of claim 13, further comprising a factor module to select, before establishing the permissible address-range and identifying the requested address-range, the data set based on at least one factor chosen from:
a set of jobs which open the data set;
a regularity threshold of opens of the data set;
a profile catalog coupled to the data set;
an activity threshold for the storage system; and
a user-provided profile for the data set which meets a priority threshold.

20. A computer program product comprising a computer readable storage medium having a computer readable program stored therein, wherein the computer readable program, when executed on a first computing device, causes the first computing device to:
select a data set based on a usage factor and a value factor;
establish, in a control block for the data set, a permissible address-range for access to a unit of storage space;
identify a requested address-range of an access request configured for the unit of storage space;
determine, by comparing the permissible address-range and the requested address-range, whether to process the access request; and
initiate an event response in response to determining to disallow processing of the access request, wherein the event response includes:
an end to the access request,
a disallowance notification for the access request, and
a storage dump of diagnostic information having a relationship to both the permissible address-range and the requested address-range that includes temporal information configured to be relatable to a specific program.
